(19) United States
(12) Patent Application Publication
(10) Pub. No.: US 2008/0065491 A1
(43) Pub. Date: Mar. 13, 2008

(54) Automated advertising optimizer

(76) Inventor: Alexander Bakman, Durham, NH (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/898,354

(22) Filed: Sep. 11, 2007

Related U.S. Application Data
(60) Provisional application No. 60/843,396, filed on Sep. 11, 2006.

(51) Int. Cl. G06Q 30/00

(52) U.S. Cl. 705/14; 715/700

(57) ABSTRACT

A method and system for automatically monitoring the performance level of various aspects of pay-per-click (PPC) and pay-per-action (PPA) advertising campaigns, and automatically revising the aspects to optimize performance levels, is provided. The advertiser is automatically notified if one or more particular aspects are resulting in less than desired click-through traffic. Further, the suspect aspects of the campaign are modified to ensure desired “click-through” regarding the advertisements and, thus, maximization of the advertiser's return on investment (ROI) with respect to the advertising campaign is achieved.

### FIELD OF THE INVENTION

The present invention generally relates to a method and system for automatically monitoring the performance level of various advertising aspects and automatically revising the aspects to optimize advertising performance levels and, more particularly, the present invention relates to a method and system that automatically monitors all aspects of a pay-per-click (PPC), or a pay-per-action (PPA), advertising campaign conducted, for example, via the Internet. Further, according to the invention the advertiser is automatically notified that one or more particular aspects of the campaign are resulting in less than desired click-through traffic. The invention, further, automatically modifies suspect aspects to ensure desired “click-through” regarding the advertisements and, thus, maximizes the advertisers return on investment (ROI) with respect to the advertising campaign.

### BACKGROUND OF THE INVENTION

Pay-per-click (PPC) search engines are search engines that offer a marketing option referred to as “pay-per-click.” PPC typically refers to the guaranteed placement of an advertisement (“ad”) on the results page of the search engine for a specific keyword or keywords in return for a specified payment from the advertiser. The specified payment is typically only due if and when a visitor to the search engine clicks on that particular ad. That is, the advertiser pays nothing for having his ad appear on the results page; he only pays the agreed upon amount, i.e., the “bid” amount, when someone actually clicks on his ad and the landing page is accessed as a result. For example, a PPC listing on a search engine results page might consist of a title, which is typically the name of the advertiser's website or a short heading of less than 50 characters or so. The listing also may include a short, typically less than 200 characters long, description of the advertiser's service.

Not surprising, PPC online advertising has become very popular. Many major search engine companies like Google, Yahoo and others have implemented it and it is the source of significant revenue for such companies. Advertisers' ads are displayed as result of a user's search along with the “natural” search results. The ads are typically displayed from the top of the page down to the bottom in a sequence. Typically, only about 5 or so ads fit to a page, the rest are displayed on subsequent pages only if a user chooses to view subsequent pages. Thus, it is very important for advertisers to have their ads displayed on the first page of search results to ensure visibility by the user when the initial search results are displayed.

Obtaining first page positioning for ads, however, is not a trivial task. Advertisers are faced with several obstacles and issues that must be overcome in order to obtain this desired positioning. For example, advertisers want their ads displayed on the first page of search results but positions on the page are not guaranteed. More particularly, ad position is typically determined by, 1) how much the advertiser is willing to pay (e.g., bid) per user click, 2) the relevancy (i.e., popularity) of the ad to the search results as measured by the number of “clicks” a particular ad receives, and, 3) many other factors. Thus, the positioning of ads is very dynamic and marketing personnel spend a lot of time trying to make sure that the ads appear in the first 5 positions on the first page of search results. Further, marketing professionals are forced to continually monitor their ads and their respective positioning on the search engine results pages and if they are not satisfied with the positions, the advertisers must either raise their bids, change the ads or come up with better keywords.

Additionally, because the ads are displayed when a person searches for a specific keyword or a phrase, marketing professionals spend a lot of time deriving all possible keywords and phrases that a user may enter so that the ad appears on more result pages and thus produces better results in the form of user clicks and raises company awareness. Generating new search keywords and phrases is an ongoing activity that needs to be done frequently to get better results from PPC advertisements.

Another issue with respect to PPC ad campaigns is that creating successful ads is a “trial and error” process both in the printed as well as the online environment. It is simply impossible to predict the performance of an ad without trying it, observing results then modifying it, observing results and continuing this cycle. This is a very time consuming process because the more often the cycle is repeated, the better the results become.

Also, as the number of online ads and keywords grow, marketing professionals spend more and more time managing them. It is not unusual to see even small companies utilizing hundreds of advertisements and thousands of keywords. In order to manage all of the advertisements and keywords, companies typically dedicate one or more people working 100% of their time on managing these online advertisements and keywords.

Lastly, search engines are beginning to replace traditional ‘yellow page’ type advertising. When people attempt to find a local product or service, they typically search for it online, i.e., via the Internet using search engines such as Google, etc. Therefore, even local merchants like pizza shop owners, hair dressers, and others now need to be easily found on the first page of search results. These small businesses typically do not have the time or knowledge with respect to creating successful online PPC ads.

Pay-per-action (PPA) advertising, introduced by Google™, Inc., is similar to PPC advertising, however, in a PPA advertising campaign the advertiser typically pays only for completed actions defined by the advertiser. For example, the advertiser would pay when a lead is obtained, a sale is completed, or a certain webpage is viewed, after a user has clicked on the advertiser's ad on a particular publisher's website.

Similar to PPC advertising, PPA advertisers set the price that they are willing to pay for specific actions, for example, a click, a purchase, or a sign-up. In PPA advertising, because advertisers are purchasing specified actions which conform to their business goals, click fraud is not as much of a problem as it might be, for example, in PPC advertising.

Accordingly, it is desirable to provide a method and a system for automatically creating and automatically managing all aspects of a PPC or PPA advertising campaign. By providing such a method and system, large, sophisticated, advertisers with numerous ads and keywords benefit from not being required to dedicate an inordinate amount of human resources to each ad and/or campaign, and smaller, e.g., local, advertisers benefit by being able to compete for ad positioning resources without being required to employ expensive advertising companies and their human resources and, furthermore, even without having extensive knowledge of PPC advertising campaigns.

### SUMMARY OF THE INVENTION

Illustrative, non-limiting embodiments of the present invention address the aforementioned and other issues related to PPC and PPA advertising. The exemplary embodiments discussed below are primarily directed to PPC advertising, however, a skilled artisan would understand that many of the aspects discussed with regard to PPC advertising can be implemented equally well in a PPA advertising campaign. Thus, it should be understood that the term pay-per-click (PPC) as used throughout is intended to refer to PPC as well as PPA advertising, i.e., a “paid search.”

An embodiment of the invention includes an automated system created as a computer program that addresses one or more of the issues mentioned above. That is, an exemplary system saves marketing professionals and business owners a significant amount of time and removes the barrier of being required to have extensive knowledge of PPC advertising to get good results from such advertisement techniques.

More particularly, an exemplary embodiment of the invention continually monitors the performance of all specified ads to ensure they appear in the first 5 positions of the first search results page by automatically raising and/or lowering keyword bids as needed. Additionally, a method in accordance with the invention also automatically generates keywords and search phrases in order to increase the number of times the ads appear in search results which, in turn, leads to more people clicking on the ad for the purpose of lead generation, such as when a potential customer is searching for a specific product or service to purchase. Furthermore, the ad being present on the first page of the search results also increases the general public awareness of the company and its products or services by exposing the ad to all users who search on a particular keyword, i.e., branding.

A method and system according to the present invention also automatically generates online ads and continuously improves them over time. It continually and automatically monitors performance of ads, notifies the advertiser when performance is less than desired, changes the ads, observes results of the changes and makes other changes if and when necessary. This cycle goes on continuously producing better results in the form of additional clicks and improved impressions.

An embodiment of the invention also enables a single marketing professional to manage very large ad campaigns consisting of hundreds of ads or more and thousands of keywords and search phrases. One reason for this is that a computer program runs in the background freeing up the marketing professional from having to spend a lot of his own time performing this work. Further, all aspects of the PPC ad campaign are automatically generated and monitored without the hands-on participation of the advertiser. That is, a system and method according to the invention automatically generates the ad campaigns and also automatically monitors various statistics related to the campaign and automatically notifies the advertiser whenever a given threshold for the statistic is crossed. For example, the system continually monitors each keyword (or ad or ad campaign, etc.) and automatically sends an e-mail to the advertiser informing that the particular keyword has resulted in a number of clicks that is lower than desired, i.e., below the chosen threshold for that keyword, ad or ad campaign, etc. The advertiser sets thresholds corresponding to respective aspects of an ad campaign, e.g., keywords, ads, etc., and when any threshold is crossed, the advertiser is automatically notified, e.g., via e-mail or some other format, that the threshold has been crossed so the advertiser can take the necessary measures to remedy the situation.

Lastly, the invention enables even minimally experienced users to achieve positive results with online PPC advertisement. Even the smallest business can generate a PPC ad campaign that results in their ad being found on the first page of a search engine's search results when customers search for their respective products and services and/or search on the generated keywords. In one embodiment the program's Startup Wizard solicits some basic information from the user about the nature of the business and the program automatically creates ads, search keywords and phrases saving the user from having to know anything about how to perform these tasks.

According to one exemplary embodiment of the invention, a method for automatically managing a pay-per-click advertising campaign is provided which includes automatically collecting statistical data corresponding to the performance of the advertising campaign, automatically generating at least one of a keyword and a phrase based on the collected data, automatically generating an ad linked to the at least one generated keyword or phrase, and automatically adjusting a bid value corresponding to the at least one keyword or phrase, wherein the generated ad is displayed on the first results page of a search engine.

According to another embodiment of the invention, a method for providing information regarding a pay-per-click (PPC) advertising campaign is provided where the method includes setting a threshold value for each of at least one statistic related to the PPC advertising campaign, continually monitoring a performance level for each of the at least one statistic related to the PPC advertising campaign, and automatically generating a notification when the performance level of at least one of the statistics crosses its respective threshold value.

According to another embodiment of the invention, a user interface is provided in connection with an online advertising campaign where the interface includes a first means for indicating a performance level of at least one aspect of a pay-per-click (PPC) advertising campaign, a second means for enabling a user to add or delete at least one of the at least one aspect whose performance level is indicated by said first means, and a third means for indicating a respective reason for a change in the performance level of the at least one aspect. Further, with respect to another aspect of this embodiment, the first means optionally includes a graph indicating the performance of the at least one aspect over time and the third means has a window overlayed on a user-selected portion of the graph.

According to yet another embodiment of the invention, a method for automatically managing a pay-per-click (PPC) advertising campaign is provided that includes monitoring a change in at least one parameter with respect to the PPC advertising campaign and displaying a graphical representation, e.g., a graph, of the at least one parameter, wherein changes, including the monitored change, in the at least one parameter are represented on the graph.

### BRIEF DESCRIPTION OF THE DRAWINGS

Objects and advantages of the present invention will become apparent to those skilled in the art upon reading this description in conjunction with the accompanying drawings, in which:

FIG. 1 is an illustration of one exemplary embodiment of a graphical user interface (GUI) in accordance with the present invention.

FIG. 2 is a flowchart diagram representing various steps conducted in accordance with an exemplary algorithm according to the present invention.

FIG. 3 is a flowchart diagram representing various steps conducted in accordance with an exemplary method according to the present invention.

FIG. 4 is an illustration of one exemplary embodiment of a login screen for a graphical user interface (GUI) in accordance with the present invention.

FIGS. 5-9 are illustrations of various exemplary system registration screens for a graphical user interface (GUI) in accordance with the present invention.

FIG. 10 is an illustration of one exemplary embodiment showing the layout of a status page screen for a graphical user interface (GUI) in accordance with the present invention.

FIG. 11 is an illustration of one exemplary embodiment of a user status page for one or more ad campaigns in accordance with the present invention.

FIG. 12 is an illustration of one exemplary embodiment of a GUI interface for changing the settings corresponding to the screen shown in FIG. 11.

FIG. 13 is an illustration of one exemplary embodiment of a campaign status page for one or more ad groups in accordance with the present invention.

FIG. 14 is an illustration of one exemplary embodiment of a GUI interface for changing the settings corresponding to the screen shown in FIG. 13.

FIG. 15 is an illustration of one exemplary embodiment of a GUI interface for changing the search engine properties corresponding to the screen shown in FIG. 13.

FIG. 16 is an illustration of one exemplary embodiment of an adgroup status page for one or more keywords in accordance with the present invention.

FIG. 17 is an illustration of one exemplary embodiment of a GUI interface for changing the settings corresponding to the screen shown in FIG. 16.

FIG. 18 is an illustration of one exemplary embodiment of a GUI interface for changing the search engine properties corresponding to the screen shown in FIG. 16.

FIG. 19 is an illustration of one exemplary embodiment of a keyword status page for one or more keyword properties in accordance with the present invention.

FIG. 20 is an illustration of one exemplary embodiment of a GUI interface for changing the settings corresponding to the screen shown in FIG. 19.

FIGS. 21-27 are illustrations of various exemplary screens/steps of a graphical user interface (GUI), used in connection with the setup of a campaign wizard utility in accordance with the present invention.

FIG. 28 is a flowchart diagram representing an application program interface (API) in accordance with an exemplary embodiment of the present invention.

### DETAILED DESCRIPTION OF EXEMPLARY EMBODIMENTS

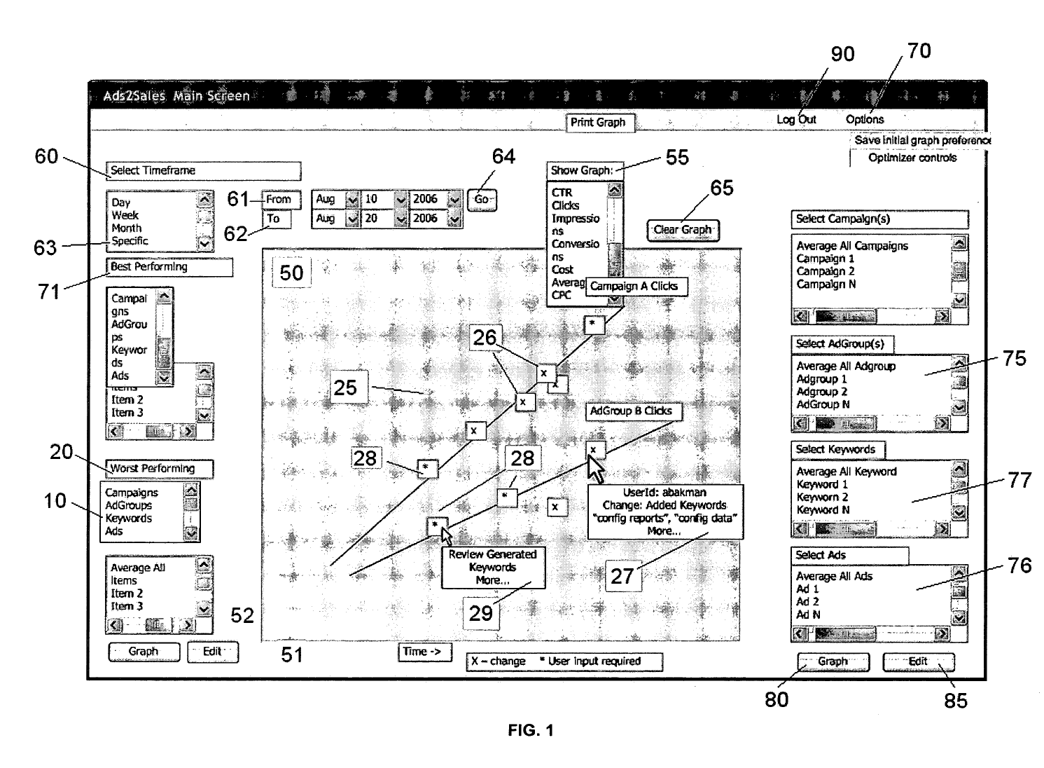

According to one exemplary embodiment, once a user logs in to the application, the main screen is presented, illustrated in FIG. 1 (MAIN SCREEN). While the main screen may appear to be busy with many controls, it is designed to save users precious time by quickly showing them how well their PPC ads and keywords are performing. For example, by selecting “keywords” (10) from the “worst performing” control (20), a user is presented with a list of keywords and phrases that are achieving the worst performance according to selected criteria, e.g., CTR (Click Through Rate), Clicks, etc. listed in the order from the very worst to the least worst.

Possibly the most important element of the main screen shown in FIG. 1 is the line graph (25). A user can select to graph any element of their PPC advertisements. Controls allow users to quickly zoom-in on problem areas at any level (e.g., adgroups, ads, keywords, etc.) and attempt to fix them. This ability is especially important when the number of ads and keywords grows as it becomes more difficult to monitor their performance.

Another unique feature illustrated by the main screen of FIG. 1 is that an embodiment of the present invention allows users to see changes made to ads and keywords and the results of these actions, whether positive or negative. By adding change indicators with tool tips that describe the change on top of the line graph, users can see what changed and the results produced by that change. This feature allows users to correlate changes made by Optimizer, or the user, to results. For example, if the Optimizer raised the bid for a certain keyword the user may see that the line curve representing clicks on the associated ad starts to climb, thus indicating the increasing number of clicks.

Various sections and functions attendant to the main screen illustrated in FIG. 1 will now be described.

The graphing area: As mentioned above, an important element of the main screen is the graphing display area (50). This element graphs performance of Campaign, AdGroups, Keywords, Ads and other elements that can be selected from the “Show Graph” (55) list box located on the upper portion of the screen. The horizontal axis (51) of the exemplary line graph shown represents the time interval which is selectable from the “Select Timeframe” (60) control.

The vertical axis (52) represents the volume that corresponds to the selected item. For example, if “clicks” are selected from the Show Graph menu (55), the vertical axis represents the number of clicks. If CTR is selected, the vertical axis shows the corresponding click through rate percentage and so on.

The user can select and graph multiple items in graph area (50) as long as the items are compatible types. For example, a user can graph CTR and conversions on the same graph because their Y axis represents percentage. Alternatively, according to one embodiment a user cannot graph clicks and CTR on the same graph because CTR is represented as a percentage and clicks as a numeric number of clicks. When the data types are compatible, the graphs are drawn on top of each other. When the “Clear Graph” (65) button is pressed or a user tries to graph incompatible elements, the graphing area is cleared. The initial graph according to this embodiment displays averaged performance of all campaigns for the last week. Further, the user can change the initial display graph by first graphing the desired graph and then selecting the “initial graph preference” from the Options menu (70).

The “X” marks (26) on the graph indicates a change. A change can be made by the Optimizer, e.g., new keyword added, or by user action. When a user places a mouse cursor over an “X” mark (26), a tooltip (27) is displayed, as shown in FIG. 1, which briefly describes the nature of this particular change. If the user clicks on the “more” hyperlink, the user will be taken to the change history screen described separately. As indicated by box 29 the “*” marks (28) on the graph indicate that user input or review is required. When a user clicks on it he will be taken to appropriate screen for review.

Time Frame Selection: A user can graph the data over any period of time for which the data exists. If the data for the time period does not exist, the program draws the graph based on the best possible fit to the data. If no data exists at all, the option is grayed out. The “From” (61) and “To” (62) controls are initially grayed out. If a user selects “Specific” (63) time frame the “Select Timeframe” control the “From” and “To” fields become non-grayed out, or active. If the user clicks on the “Go” button (64), the graph is redrawn for whatever the currently selected context and time frame is.

Text Boxes: The user uses controls on the left hand side if he wants to see Best performing (71) or Worst performing (20) Campaigns, AdGroups, Keywords or Ads. If the user wants to see performance of specific Campaigns, AdGroups, Keywords or Ads the right-hand side of the screen is utilized. When the user selects a specific campaign, AdGroup, Keywords and Ad, textboxes get refreshed with relevant, dependent data.

The user at any time can make one or more selections in any of the text boxes. All dependent text boxes “downstream” will auto update their contents, except in cases where a selection is made in Keywords or Ads text boxes. For example, if a user selects a specific AdGroup (75), the keyword text box (77) will load all keywords that belong to the AdGroup, and the Ads text box (76) will load on the Ads that belong to the AdGroup.

When the user clicks on the “Best Performance” (71) and “Worst Performance” (20) areas, the list is ordered according to the graphing criteria specified at the top of the graph. For example, if CTR is selected and the user wants to see the “best performing” keywords, a list of keywords starting with the highest CTR keyword is displayed. Double-clicking on any item in the text boxes causes a graph to be drawn. Single clicking simply selects the item. Users can select one or more items by holding down the CTRL and SHIFT keys. Clicking on “Graph” (80) causes the software to draw graphs for all selected items as long as the data types are compatible. Clicking on “Edit” (85) opens an appropriate “editor” for the item. According to an exemplary embodiment, only one item type (e.g., keyword, adgroup, ad, etc.) is edited at a time. If multiple item types are selected, the editor for the last item selected will open.

Menu items: “Logout” (90) will logout the user out of the software to an initial screen. All screens that save user preferences, optimization algorithm parameters, etc. are accessible from “Options” (70).

An embodiment consistent with the present invention comprises a method of automatically creating and managing a PPC ad campaign. The invention can take the form of an entirely hardware embodiment, an entirely software embodiment or an embodiment containing both hardware and software elements.

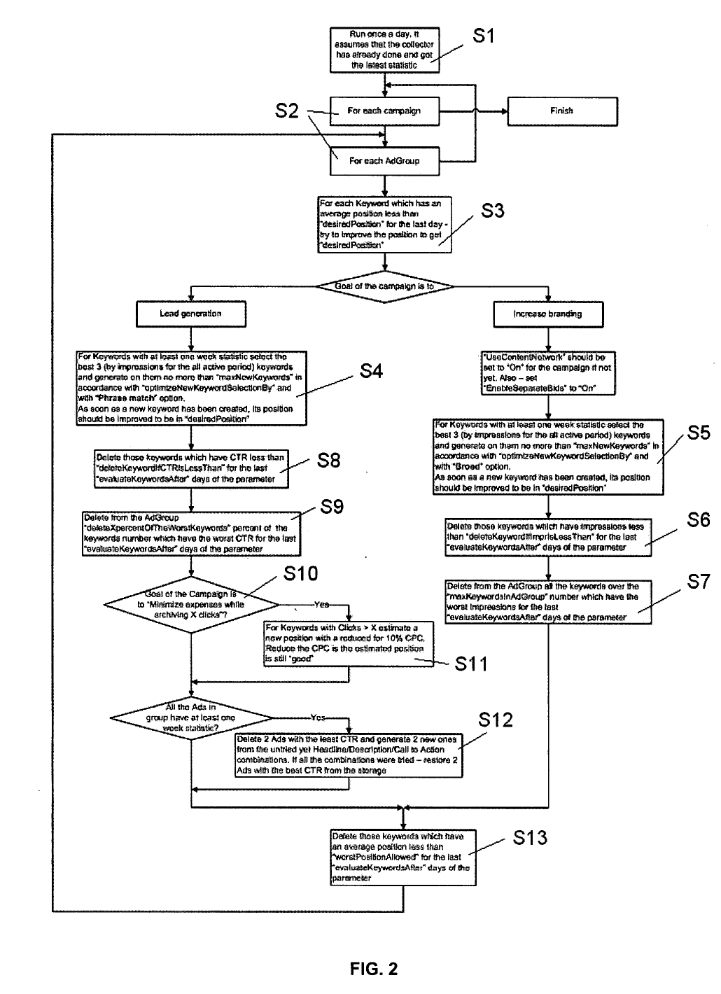

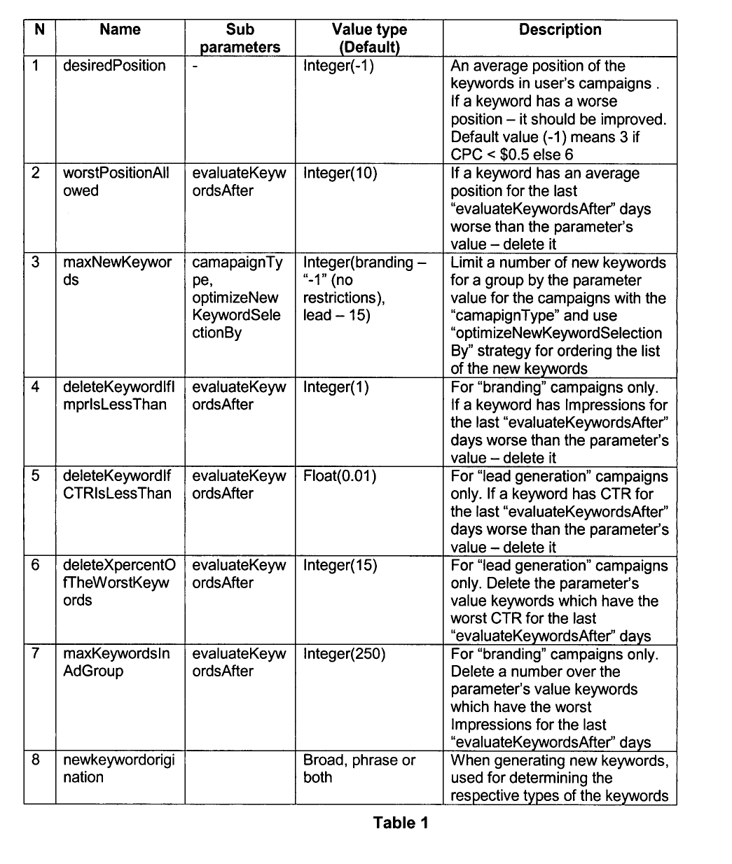

For example, FIG. 2 illustrates an embodiment in accordance with the invention. Referring to FIG. 2, a general, overall, algorithm is illustrated with respect to an exemplary embodiment. Tables 1 and 2, illustrate input parameters and sub parameters, respectively, to the algorithm of FIG. 2.

Referring to Table 1, to make the exemplary algorithm more flexible to a respective user's needs, it is parameterized by one or more of a set of parameters, which the user is able to change. These parameters are listed in Table 1.

Further, an Input parameter file is stored for use by a computer program in accordance with a further embodiment. For example, the parameters list is stored in an XML file named “parameters.xml” with the following structure, except for obligatory service tags (not shown).

```
<optimizerParameters>
  <desiredPosition value=”X”/>
  <worstPositionAllowed value=”X” evaluateKeywordsAfter=”D”/>
  <maxNewKeywords value=”X” camapignType=”type”
        optimizeNewKeywordSelectionBy=”strategy”/>
  <deleteKeywordIfImprIsLessThan value=”X”
  evaluateKeywordsAfter=”D”/>
  <deleteKeywordIfCTRIsLessThan value=”XX.XX”
  evaluateKeywordsAfter=”D”/>
  <deleteXpercentOfTheWorstKeywords value=”X”
  evaluateKeywordsAfter=”D”/>
  <maxKeywordsInAdGroup value=”X” evaluateKeywordsAfter=”D”/>
</optimizerParameters>
```

A description of the various blocks provided with respect to the flowchart of FIG. 2 is now provided.

Step S1: In accordance with this step, S1, it is assumed that the algorithm is scheduled to run automatically each day when, 1) the corresponding to the controlled campaigns “statRecord” and report objects are prepared by the search engine, e.g., Google, for the last day. According to Google, statRecords become valid with 3 hour intervals, i.e., reporting is not real-time. Clicks and impressions received in the last 3 hours may not be included here and there is a 24 hour delay in conversion tracking reporting. Due to the 3 hour delay in statRecords reporting, one reasonable time to collect the data is very early in the morning, e.g., at 3:00 am PST, to collect the previous 24 hours of data ending at midnight of that day.

In addition to, or alternatively, according to the first step, it is assumed that the algorithm is scheduled to run automatically each day when, 2) data corresponding to the controlled campaigns “statRecord” and report objects are collected by a Collector service and stored into the database. The Optimizer service does not read any statistic information from the search engine, but from its own database only. For instance, the Collector service is run at 3:05 am PST and usually it takes about 5 minutes to do all for the current 2 campaigns.

Step S2: This step, S2, is responsible for setting values of the input parameters by reading them from the file or by default.

Step S3: This step should be performed for all keywords in the selected AdGroup. Specifically, step S3 is performed for the each keyword which, 1) has an average position worse than the value of “desiredPosition” parameter, or 2) has an average position that is unknown for any reason.

The position optimization algorithm according to this exemplary embodiment as follows:
1) on the first step should be estimated an average new position through TrafficEstimatorService with newMaxCPC which is in the middle between the current maxCPC and maxUserMaxCPC;
2) if the estimated position gets the required one—try to estimate an average new position with another newMaxCPC which is in the middle between the current newMaxCPC and the current maxCPC;
3) if the estimated position doesn't get the required one—try to estimate an average new position with another newMaxCPC which is in the middle between the current newMaxCPC and maxUserMaxCPC;
4) repeat steps 3 or 4 no more than 7 times;
5) if an estimated on step 2 new average position doesn't get the required one—exit the loop and apply the previous newMaxCPC;
6) if an estimated on step 2 new average position gets the required one and newMaxCPC is not more the current maxCPC for 10 percent—exit the loop and apply the current newMaxCPC;
7) if the algorithm made 8 attempts to find a new MaxCPC but didn't get the required position due to exceeding maxUserMaxCPC—this keyword can not be improved.

The following is an exemplary code sample in accordance with step S3:

```
maxCPC - current effective maxCPC of the keyword;
maxUserMaxCPC - max user allowed CPC;
minNewMaxCPC = maxCPC;
maxNewMaxCPC = maxUserMaxCPC;
tmpNewMaxCPC = tmpNewAvgPos = 0;
for (i=0; i<8; i++ )
{
  newMaxCPC = (maxNewMaxCPC − minNewMaxCPC) / 2;
  newAvgPos = EstimateNewPos(newMaxCPC);
  requiredPos = (desiredPosition( ) == −1) ? ((newMaxCPC < $0.5) ? 3 :
6) : desiredPosition( );
  if (newAvgPos <= requiredPos)
  {
  if (newMaxCPC < maxCPC*1.1)
  {
      break;
  }
  maxNewMaxCPC = newMaxCPC;
      tmpNewMaxCPC = newMaxCPC;
  tmpNewAvgPos = newAvgPos;
  }
  else
  {
      if (tmpNewMaxCPC != 0)
      {
          newMaxCPC = tmpNewMaxCPC;
  newAvgPos = tmpNewAvgPos;
          break;
  }
      minNewMaxCPC = newMaxCPC;
  }
}
if (newAvgPos <= requiredPos)
{
  Apply(newMaxCPC);
}
else
{
  // TODO - position of the keyword can not be improved automatically
}
```

Step S4: This procedure is applied in both types of campaigns, i.e., where the purpose is to increase branding and where the purpose is lead generation, with some changes depending on the campaign type.

According to one embodiment, step S4 is performed for the all the keywords in the selected AdGroup, which have the collected statistic in the database for the last week at least. The list of such keywords is sorted by CTR (Lead Generation) or by Impressions (Increase Branding) parameter, which should be averaged for each keyword for a long enough period (but no more than 365 days). From the list the three best keywords are selected in accordance with the sorting parameter.

For example, for each selected Keyword, the following is performed:
1) request a list of variations with “Phrase Match” (Lead Generation) or “Broad” (Increase Branding) parameter or using new keyword selection value;
2) for the each variation get “searchVolume” and “advertiserScore” parameters;
3) drop from the list all the variations which are already presented in this or in any other AdGroup of this campaign to avoid competing with itself (TODO—add search in all other campaigns too);
4) drop from the list all the variations which are existed in the lists of negative keywords in the campaign and all the AdGroups of the campaign;
5) order the variation list in accordance with a strategy of “optimizeNewKeywordSelectionBy” parameter of corresponding “campaignType” and drop from the bottom of the list all the variations over than “maxNewKeywords” number;
6) for the each variation try to find maxCPC parameter from AdGroup default maxCPC and maxUserMaxCPC to get a “good” position. Create the variation with the found maxCPC parameter.

A “Good” position and the optimization algorithm mean exactly the same as it is described above with respect to Step S3, with one exception. If the algorithm was unable to find the appropriate maxCPC to get the “good” position—the keyword is created with maxCPC=maxUserMaxCPC/2.

Steps S5 and S6: There are two such procedures with the same point—delete keywords with low quality to prevent falling quality of the whole AdGroup. That is, with respect to a campaign for which an increase in branding is sought, the quality is rated by Impression parameter and compared with the “deleteKeywordlflmprlsLessThan” parameter, i.e., S6. Alternatively, regarding ad campaigns for which lead generation is sought, the quality is rated by CTR parameter and compared with “deleteKeywordlfCTRlsLessThan” parameter, i.e., S5.

To compare there should be used an averaged value of the corresponding to the campaign goal parameter for the last “evaluateKeywordsAfter” days of the corresponding parameter. The keywords which do not have the collected statistic for that number of days should not be taken into the processing.

Step S7: As illustrated, this procedure is applied in the “Increase Branding” campaigns only. The point of this step is based on an empiric rule that the search engine, such as Google, prefers Ads with a better CTR values even if they have a lower CPC value. Another restriction is that an AdGroup can not contain more than 500 keywords.

Step S7 should be done for the all keywords in the selected AdGroup, which have the collected statistic in the database for the “evaluateKeywordsAfter” days of “maxKeywordsInAdGroup”. The list of such keywords should be sorted by averaged Impressions parameter by decrease.

Finally, if the list contains more than “maxKeywordsInAdGroup” keywords—from the search engine should be deleted all the keywords from “maxKeywordsInAdGroup”+1 and up to the end of the list with the worst impressions.

Step S8: Step S8 is applied in the “Lead Generation” campaigns only. The point of this step is based on an empiric rule that a search engine prefers Ads with a better CTR value even if they have lower CPC value. Thus, keywords with a low CTR parameter should be deleted and in general an AdGroup should have as few Keywords as possible. This is done for the all keywords in the selected AdGroup, which have the collected statistic in the database for the “evaluateKeywordsAfter” days of “deleteXpercentOfTheWorstKeywords”. The list of such keywords should be sorted by averaged CTR parameter by decrease, N is the size of the list. Then, from the search engine should be deleted N*“deleteXpercentOfTheWorstKeywords”/100 words from the bottom. It should be noted, an integer round-up is used here, so if the formula result is less than 1, no words will be deleted from the group.

Steps S9 and S10: Steps S9 and S10 operate for the campaigns for which the user has set some limit of clicks, which is OK for him and would be useful to minimize expenses while getting this click number. Also, these steps are applied in the “Lead Generation” campaigns only.

Steps S9 and S10 are performed for the all keywords in the selected AdGroup, which have the collected statistic in the database for the last week at least and have Clicks more than XClicks parameter for the campaign should be done the following:
1) estimated an average new position through TrafficEstimatorService with newMaxCPC which is less than the current maxCPC for 10%;
2) if the estimated positions is “good”—set the newMaxCPC for the keyword.

Steps S11 and S12: The point of steps S11 and S12 is to vary Ads to find by an experimental way the best combination of the headline, description and call-to-action. These steps are performed in the “Lead Generation” campaigns only.

Steps S11 and S12 are performed when all the ads in the selected AdGroup have the collected statistic in the database for the last week at least and in the following order:
1) the list of the Ads should be sorted by averaged CTR for the entire collected statistic but no more than 365 days;
2) only the best Ad in the list should be stayed all other—deleted from Google;
3) from the given by the user “headline—description—call-to-action” should be found at least 2 unapplied to the AdGroup previously Ads. If such combinations is less than 2—from the previously applied to the AdGroup Ads should be found one or two ones with the best average CTR in the past;
4) 2 new ads should be applied to the AdGroup.

Step S13: The point of this step is to delete keywords with low quality to prevent falling quality of the whole AdGroup. This should be done for the all keywords in the selected AdGroup, which have the collected statistic in the database for the “evaluateKeywordsAfter” days of “worstPositionAllowed” parameter. The list of such keywords should be sorted by average position parameter by decrease. To compare there should be used an averaged value of the average keyword position parameter for the last “evaluateKeywordsAfter” days. The keywords which don't have the collected statistic for that number of days shouldn't be taken into the processing.

Next, an exemplary embodiment of a user interface (UI) in accordance with the present invention is described. For example, in accordance with this embodiment, the UI is implemented as a website interface.

FIG. 2, below, is a flowchart diagram depicting the process of an exemplary UI with respect to the present invention.

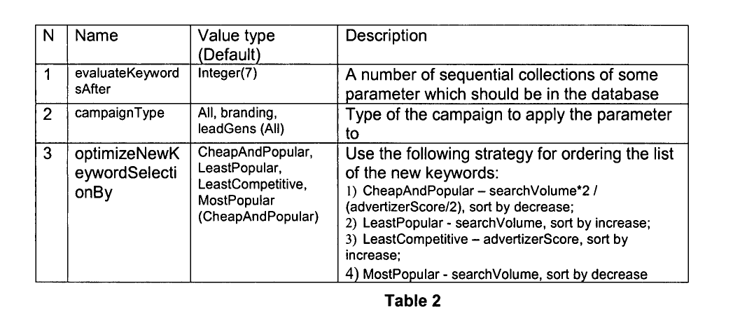

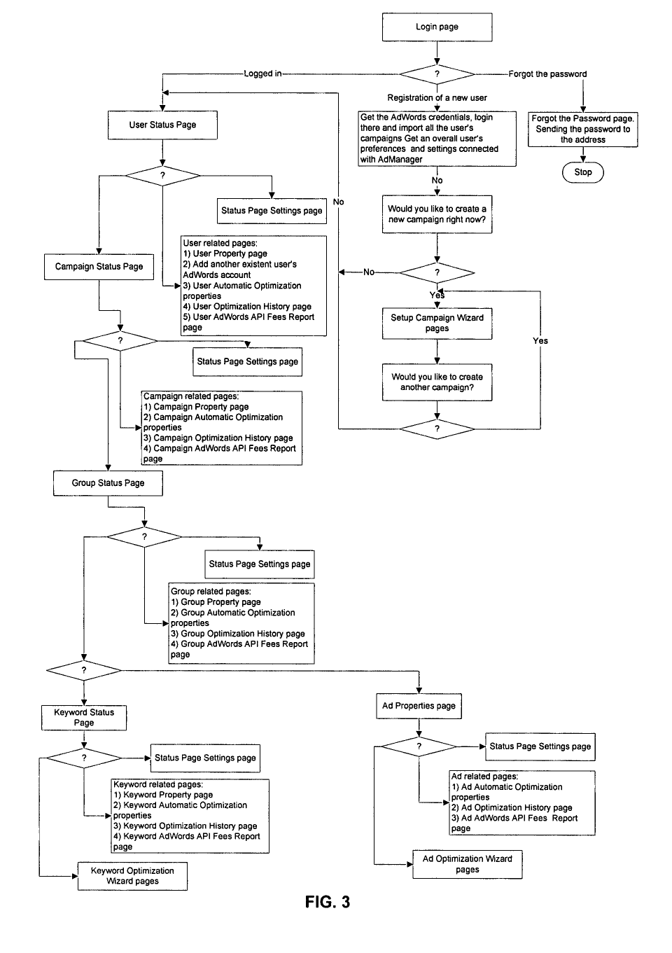

The following description details an exemplary embodiment with respect to the various blocks shown in the flowchart shown in FIG. 3.

Login Page:

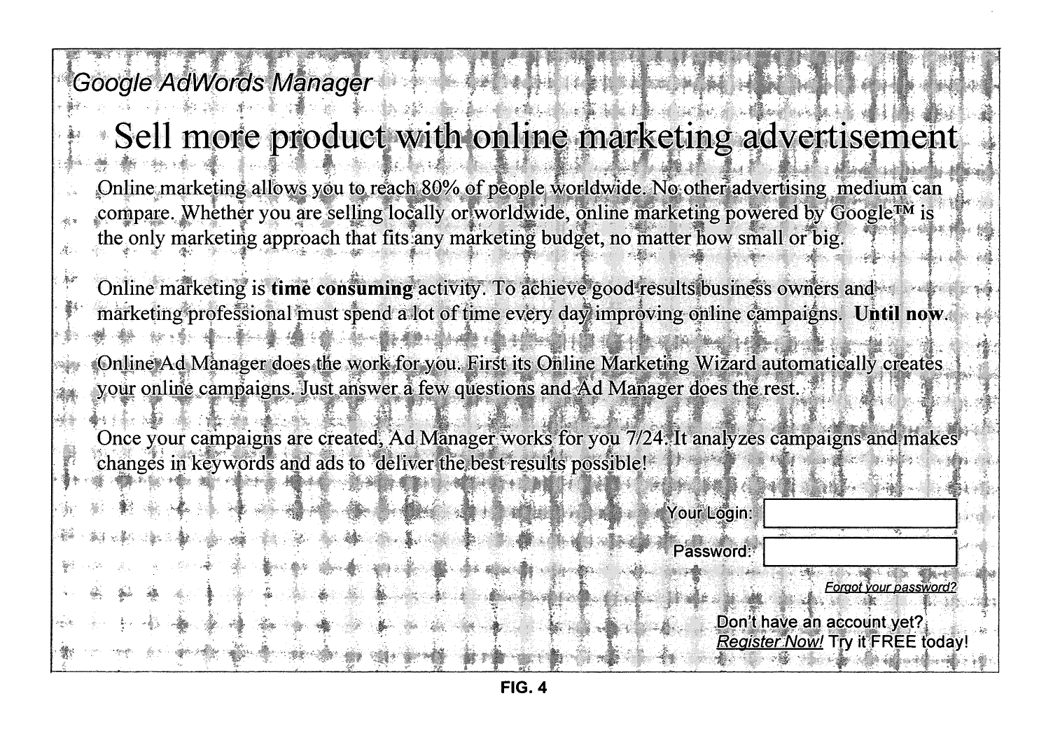

The content of the page is shown on FIG. 4.

Register Pages Wizard:

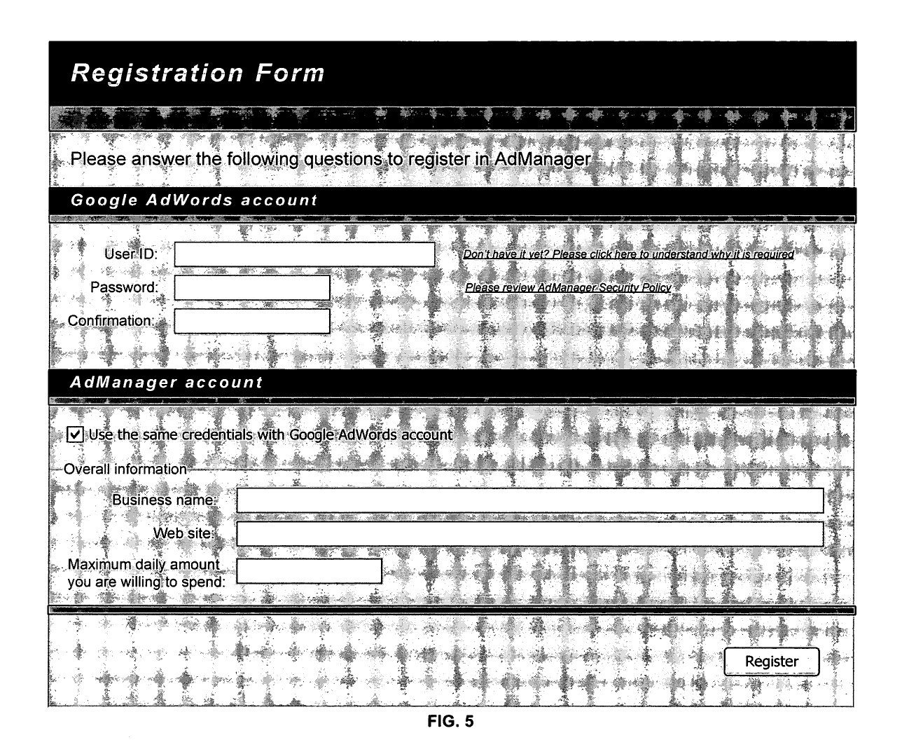

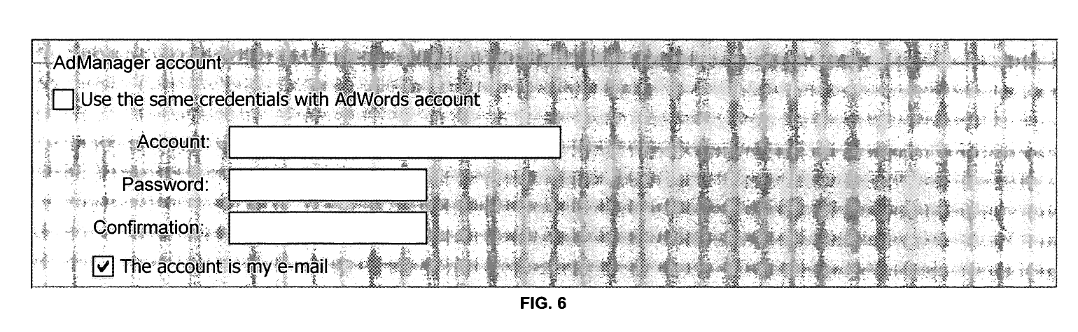

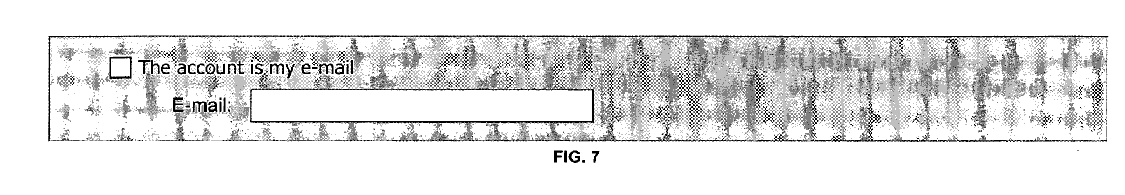

According to one embodiment, the content of user exemplary registration pages are shown in FIGS. 5-9.

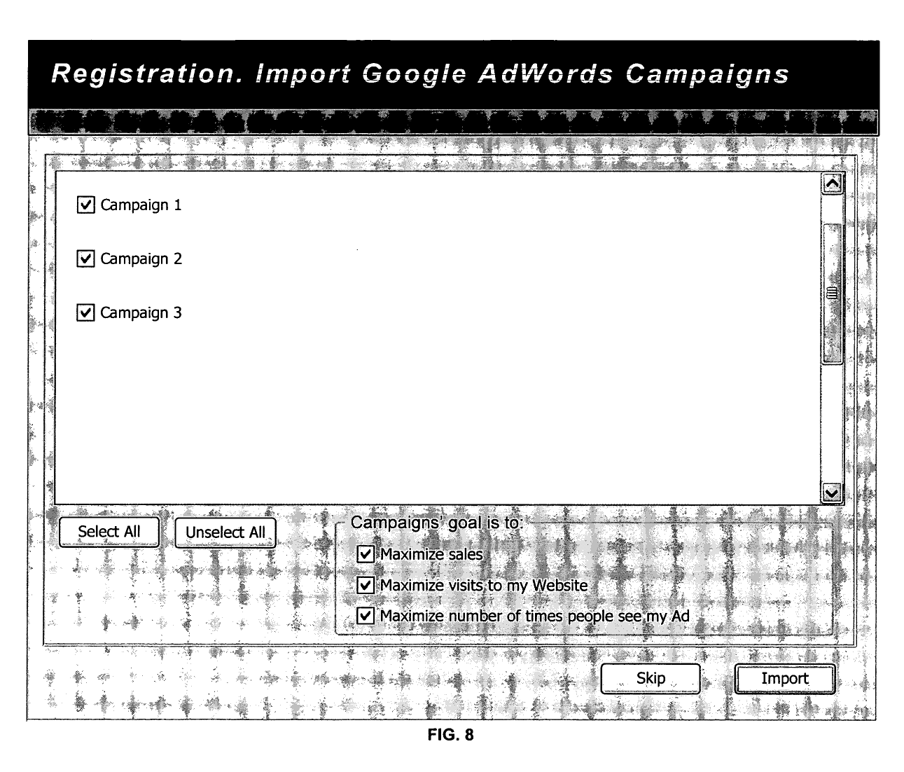

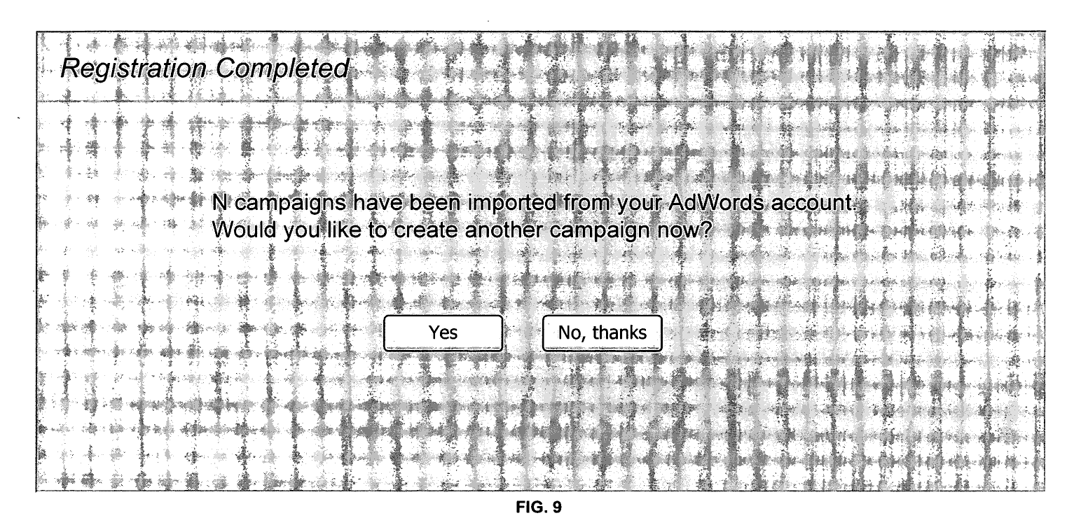

According to this exemplary embodiment, as soon as the campaigns selected by the user have been imported, the page as shown in FIG. 8 is displayed to the user. Subsequently, a registration completed screen as shown in FIG. 9 is displayed notifying the user of, for example, the number of imported campaigns and inquiring whether it is desired to import any additional campaigns.

Status Pages (User, Campaign, Group, Ad, Keyword):

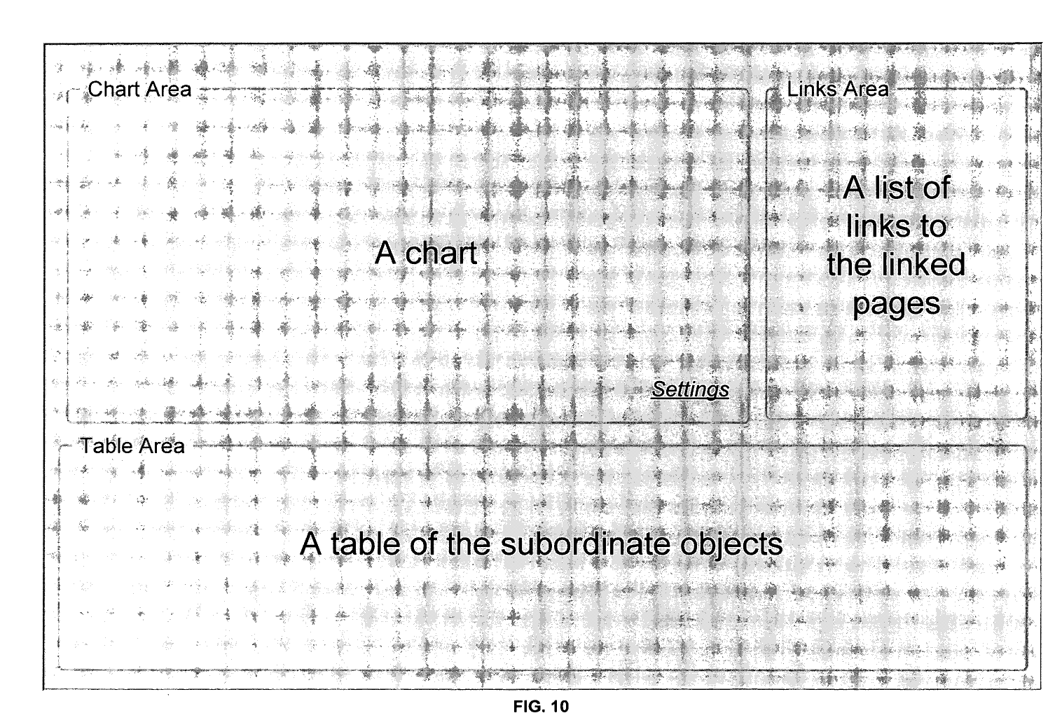

As shown in FIG. 10, a status page(s) is displayed including a “chart area”, a “links area” and a “table area”. According to this exemplary embodiment, the chart area will show an overall status of the object. Included in the chart area is a “Settings” hyperlink which is a link to a properties page with settings that, for example, permit the user to configure: 1) Which data elements they want to graph (e.g., Clicks, Impressions, CPC, CTR, Conversions, etc; 2) Pick a start and end time frame (e.g., end time frame can be “today” “yesterday” or “last 7 days”).

The “table area” contains a list of the subordinated objects. Each line has a hyperlink to the object and an overall index—e.g., how are things with the object? So the table allows the user to drill down and find out—what's wrong.

The “Links Area” is a list of hyperlinks to pages with service functions or extended information for the object.

User Status page—The layout of the user status page is shown on FIG. 11.

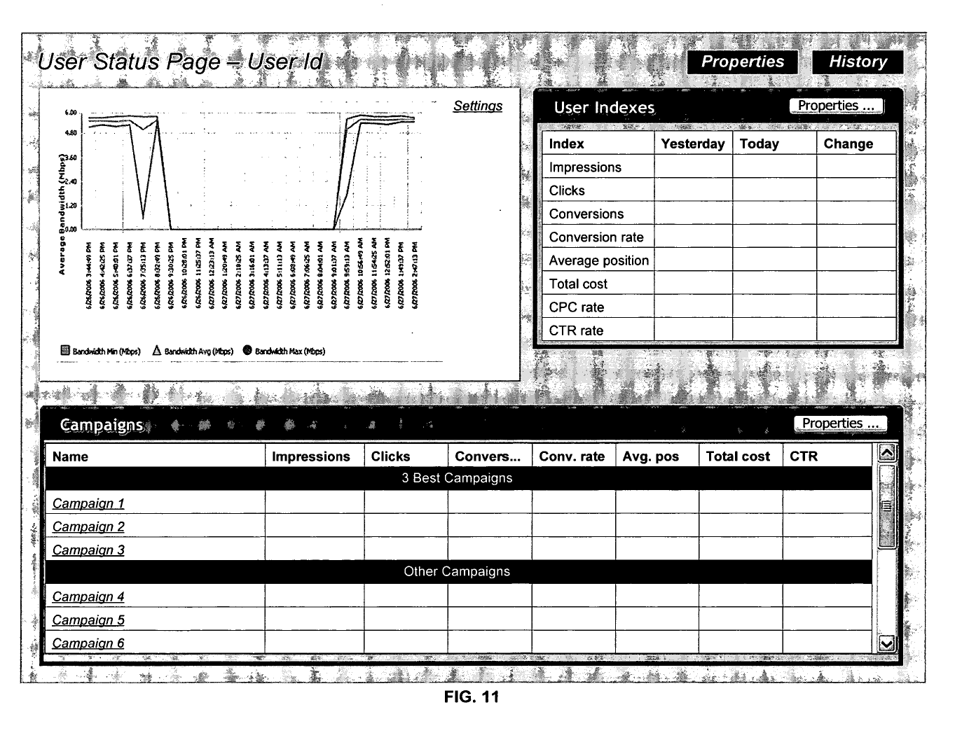

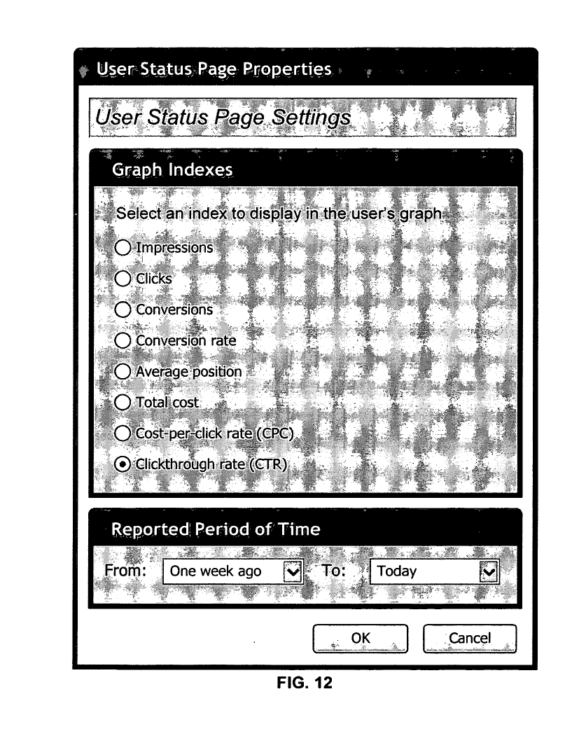

As shown in FIG. 11, the chart area displays the dynamics of some certain index of all user's campaigns for some certain time period. To change the displayed index or time period, the user clicks the “Settings” link. By that click there is displayed a popup window with the form that is shown on FIG. 12. With respect to FIG. 11;
a) “User indexes” table shows in a “stock exchange quotation”-mode absolute values of user's campaigns indexes (summary or average) for two points of time and absolute change. Increases can be displayed in a green color, decreases—in a red color, for example.
   To change the reported points of time, the user clicks the “Properties” button in the table caption.
b) “Campaigns” table contains a list of all the user's campaigns with the corresponding indexes.
   Rating of the campaigns in the table is based on CTR index.
c) “Properties” button—will allow to the user to view and change (where it is possible) his Google AdWords settings and AmManager settings, which are required for the background optimization process and so on.
d) “History” button which allows the user to review all the AdManager connected actions with user's campaigns (were made explicitly through the UI or indirectly by the Optimizer service).

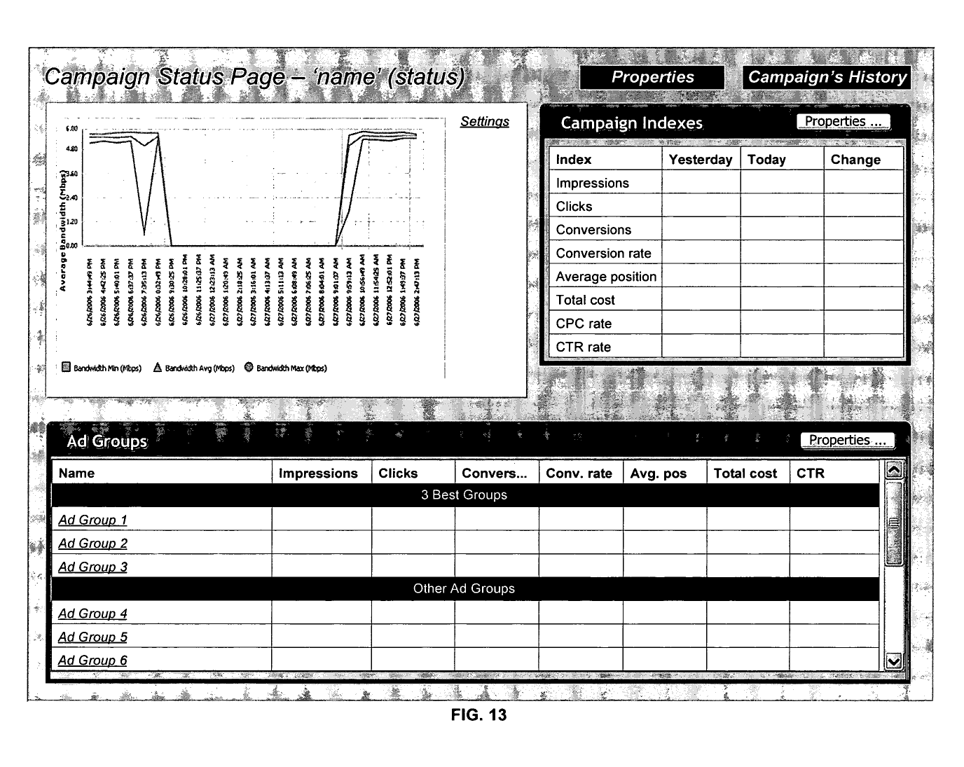

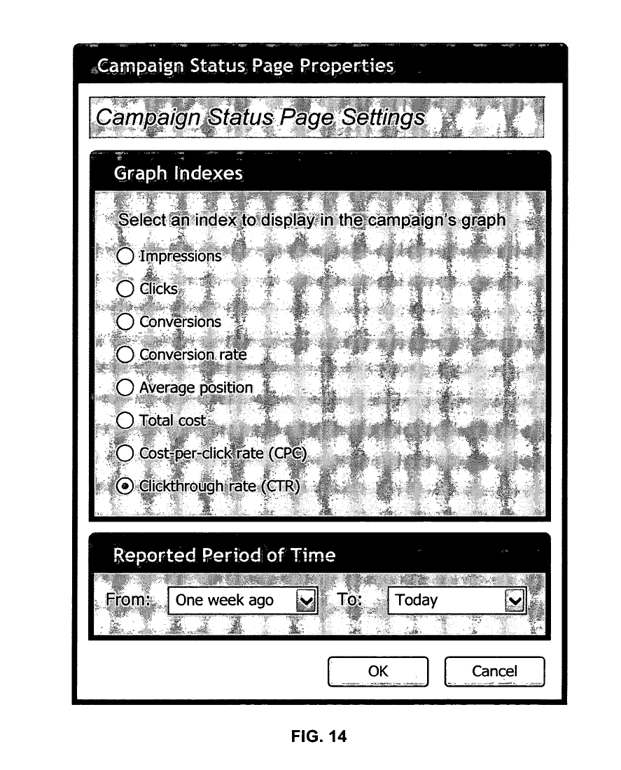

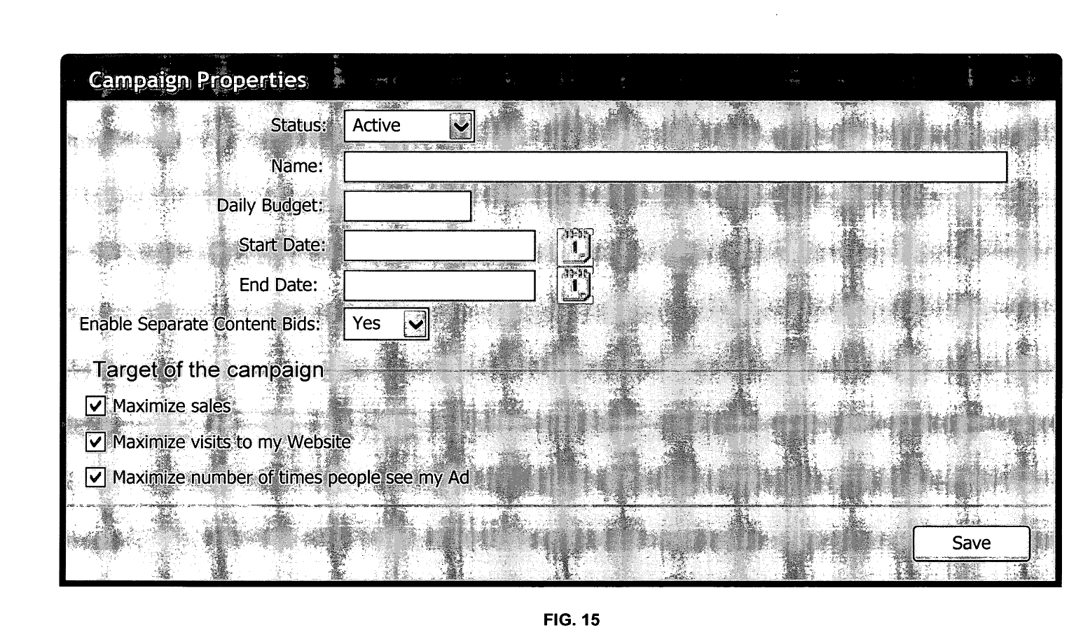

Campaign Status page: An exemplary layout of a campaign status page is shown on FIG. 13.
a) chart area displays the dynamics of some certain index of all campaign AdGroups for some certain time period. To change the displayed index or time period, the user clicks the “Settings” link.
   By that click there is displayed a popup window with the form that is shown in FIG. 14.
      As shown in FIG. 13;
b) “Campaign indexes” table shows in a “stock exchange quotation”-mode, absolute values of the campaign AdGroup indexes (summary or average) for two points of time and absolute change. Increases are displayed, for example, in a green color, decreases—in a red color. To change the reported points of time, the user clicks the “Properties” button in the table caption.
c) “AdGroups” table contains a list of all the user's campaigns with the corresponding indexes.
   Rating of the AdGroups in the table should be depended on the current campaign strategy:
      For example,
maximize visits to my web-site—on the clicks amount;
maximize number of time people see my Ad—on the impressions amount.
d) “Properties” button—will allow the user to view and change (where it is possible) the Google AdWords and AmManager settings, which are required for the background optimization process and so on. By click on that button, a popup window with the form is shown on FIG. 15 is displayed.
e) “Campaign's History” button (FIG. 13) allows to the user to review all the AdManager connected actions with the selected campaign (were made explicitly through the UI or indirectly by the Optimizer service).

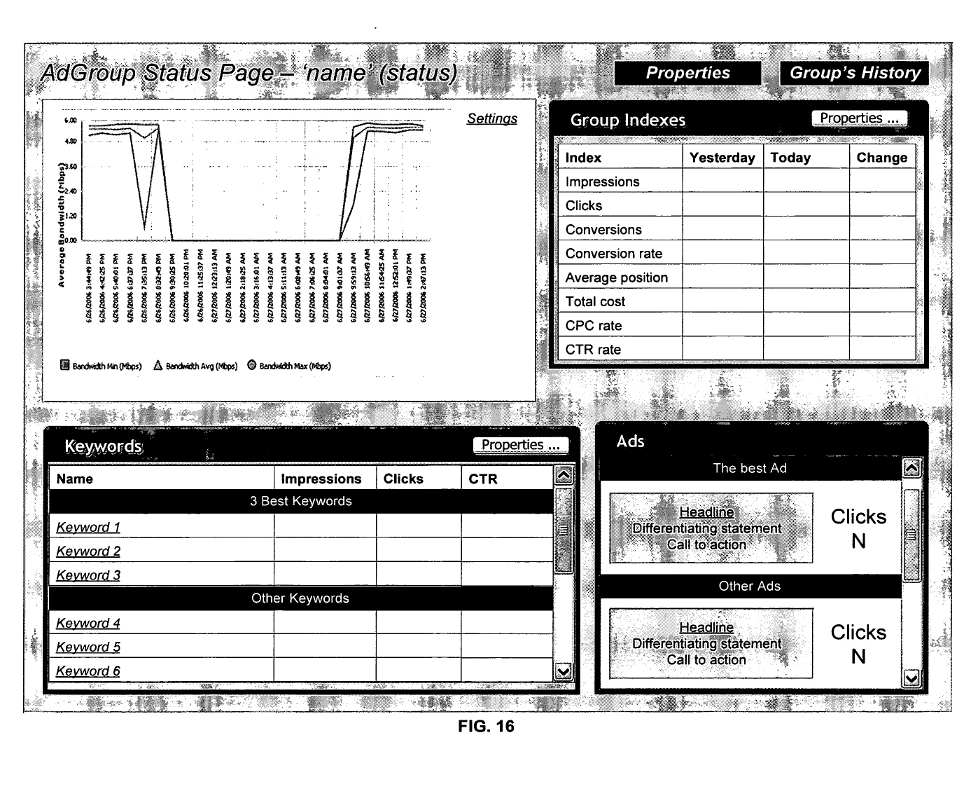

AdGroup Status page: The layout of the AdGroup status page is shown on FIG. 16.

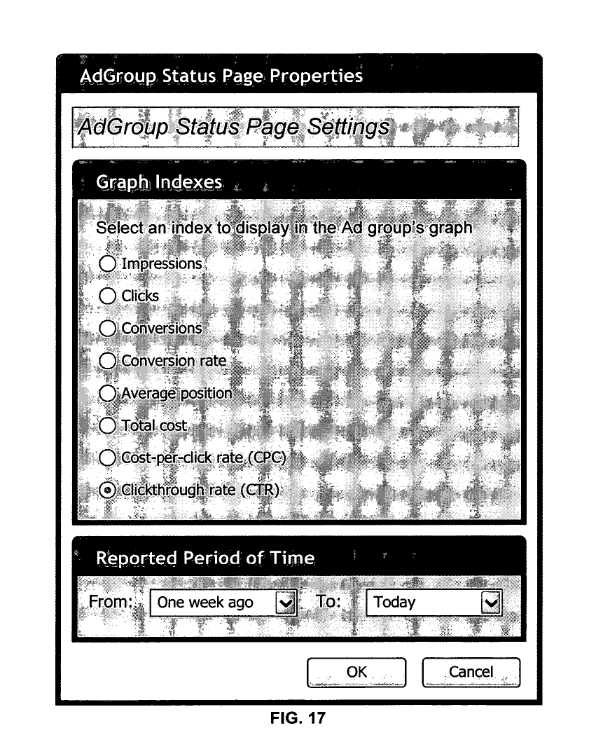

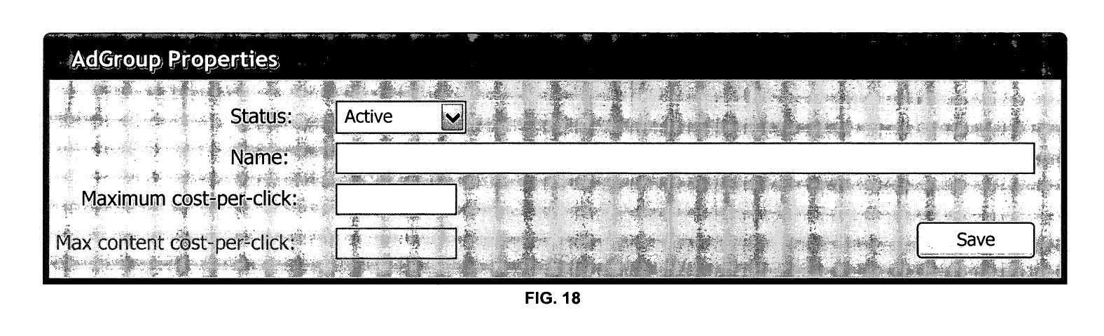

a) The chart area, e.g., in the upper left corner, displays the dynamics of some certain index of all AdGroup keywords for some certain time period. To change the displayed index or time period, the user clicks on the “Settings” hyperlink. By that click there is displayed a popup window with the form that is shown on FIG. 17.
b) The “Group indexes” table on FIG. 16 in a “stock exchange quotation”-mode, displays absolute values of the AdGroup keyword indexes (summary or average) for two points of time and absolute change. Increases are displayed, for example, in a green color, decreases—in a red color. Additionally, to change the reported points of time, the user clicks the “Properties” button in the table caption.
c) The “Keywords” table contains a list of all the AdGroup keywords with the corresponding indexes. Rating of the keywords in the table depends on the current campaign strategy, for example,
   maximize visits to my web-site—on the clicks amount;
   maximize number of time people see my Ad—on the impressions amount.
d) The “Ads” table contains a list of all the Ads in the AdGroup. Rating of the keywords in the table should be depended on the clicks amount.
e) The “Properties” button—allows to the user to view and change (where it is possible) the search engine settings, such as Google AdWords and AmManager settings, which are required for the background optimization process and so on. By click on that button, a popup window with the form is shown on FIG. 18 is displayed.
f) The “AdGroup's History” button allows the user to review all the AdManager connected actions with the selected AdGroup (made explicitly through the UI or indirectly by the Optimizer service).

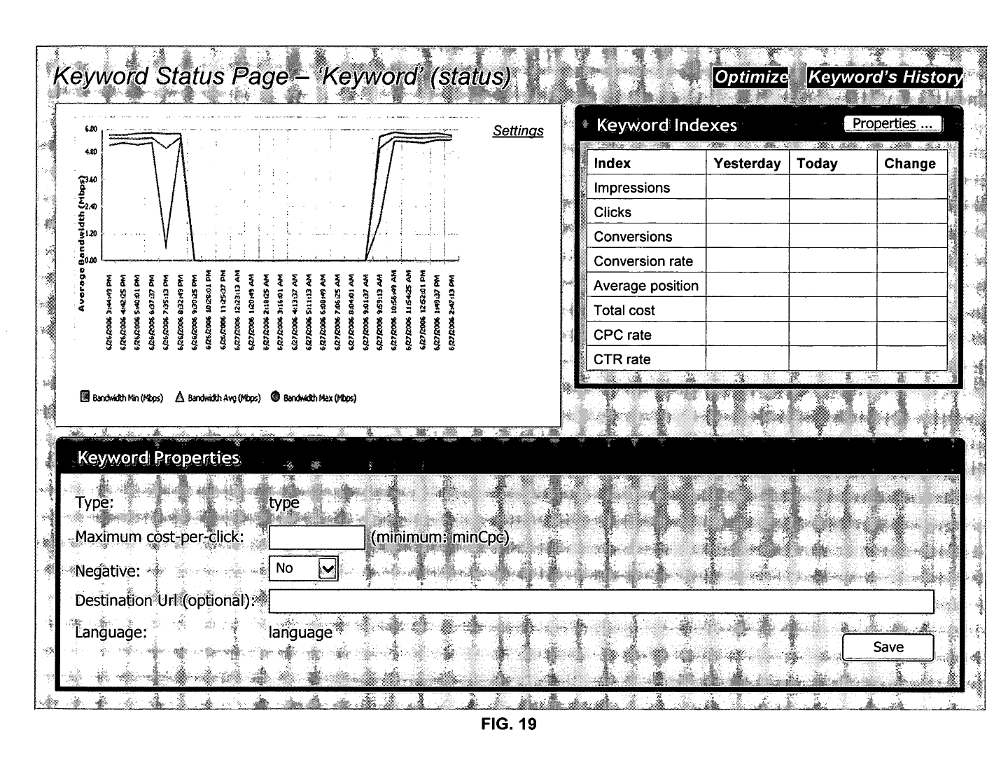

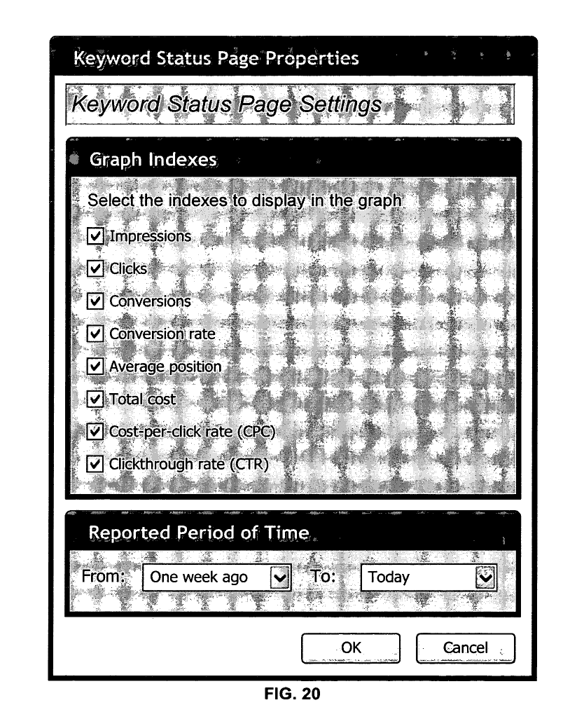

Keyword Status page: The layout of the keyword status page is shown on FIG. 19.
a) The chart area of FIG. 19 displays the dynamics of indexes, selected by the user, of the keyword for some certain time period. To select the displayed indexes or time period, the user clicks to the “Settings” link. By that click there is displayed a popup window with the form that is shown on FIG. 20.
b) “Keyword indexes” table shows, in a “stock exchange quotation”-mode, absolute values of the keyword indexes for two points of time and absolute change. Increases are displayed, for example, in a green color, decreases—in a red color.
   To change the reported points of time, the user clicks the “Properties” button in the table caption.
c) “Keyword Properties” form allows the user to view and change (where it is possible) the search engine settings, such as Google AdWords and AmManager settings, which are required for the background optimization process and so on.
d) “Keyword's History” button which should allow to the user to review all the AdManager connected actions with the selected keyword (made explicitly through the UI or indirectly by the Optimizer service).
e) “Optimize” button will display a wizard, which will allow to the user to optimize an average position (via CPC parameter) of the keyword or to generate keyword variation.

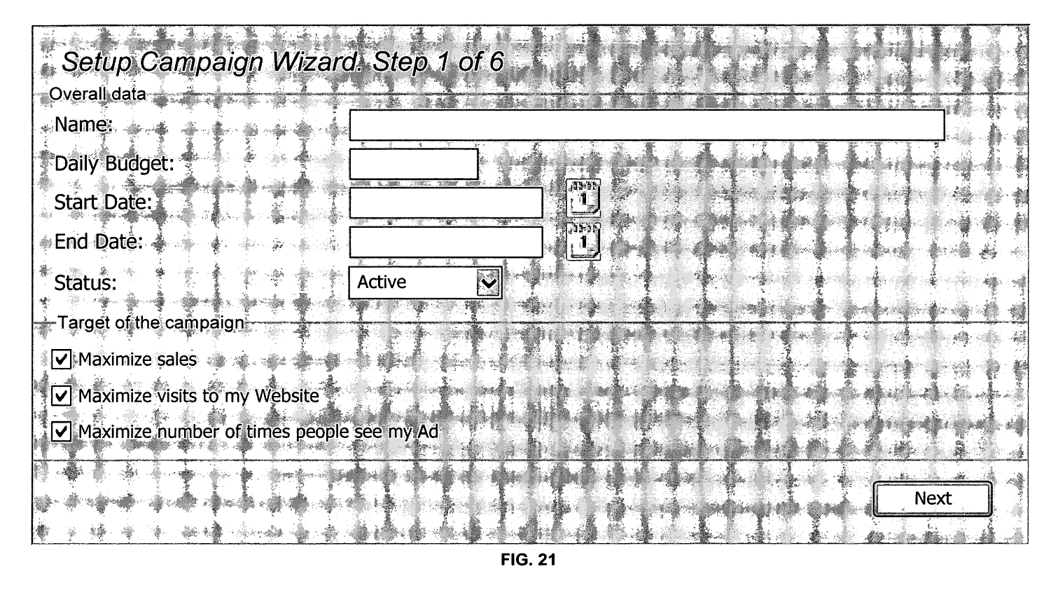

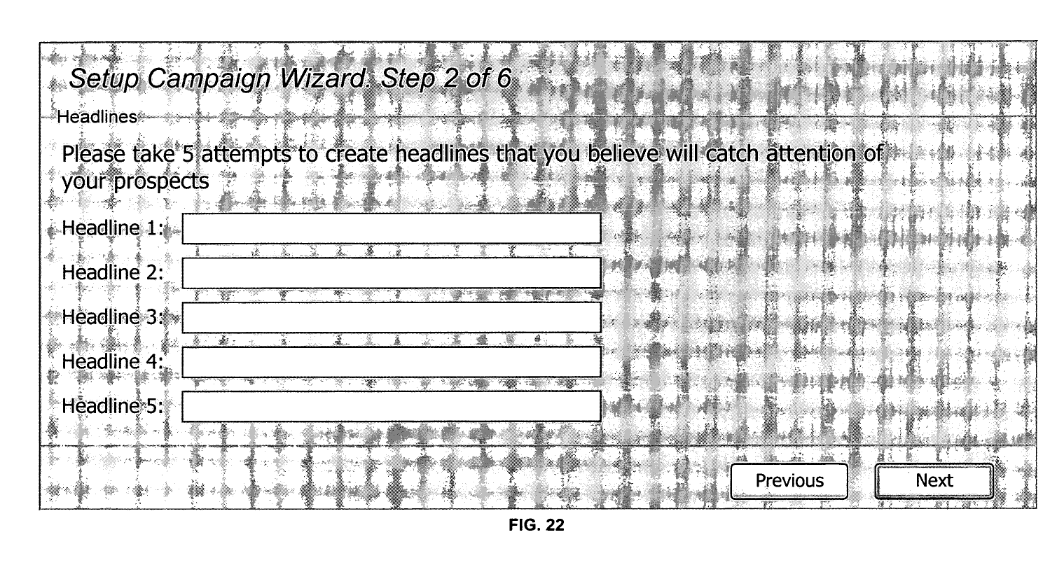

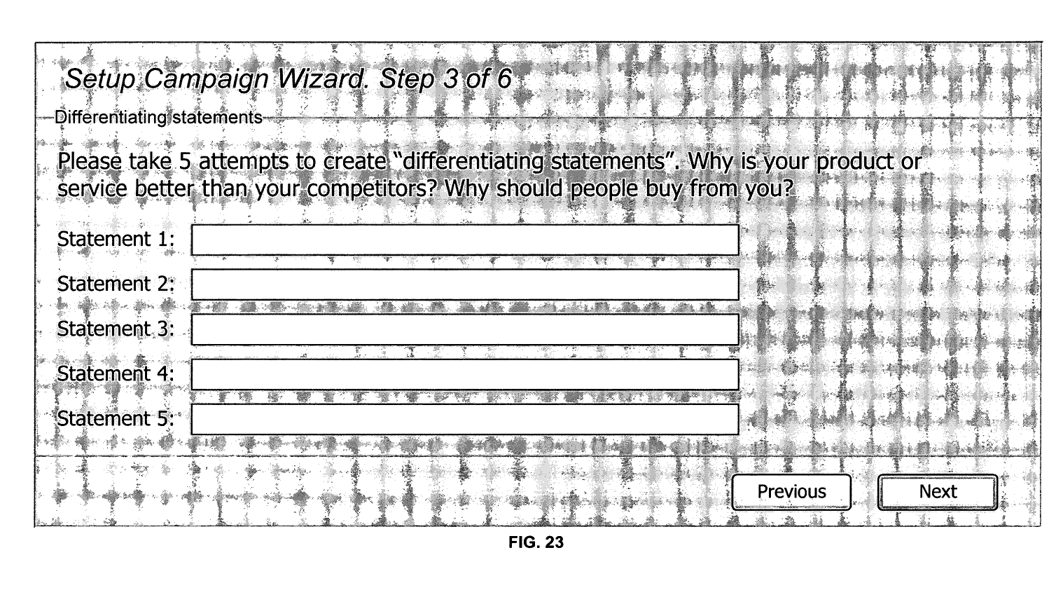

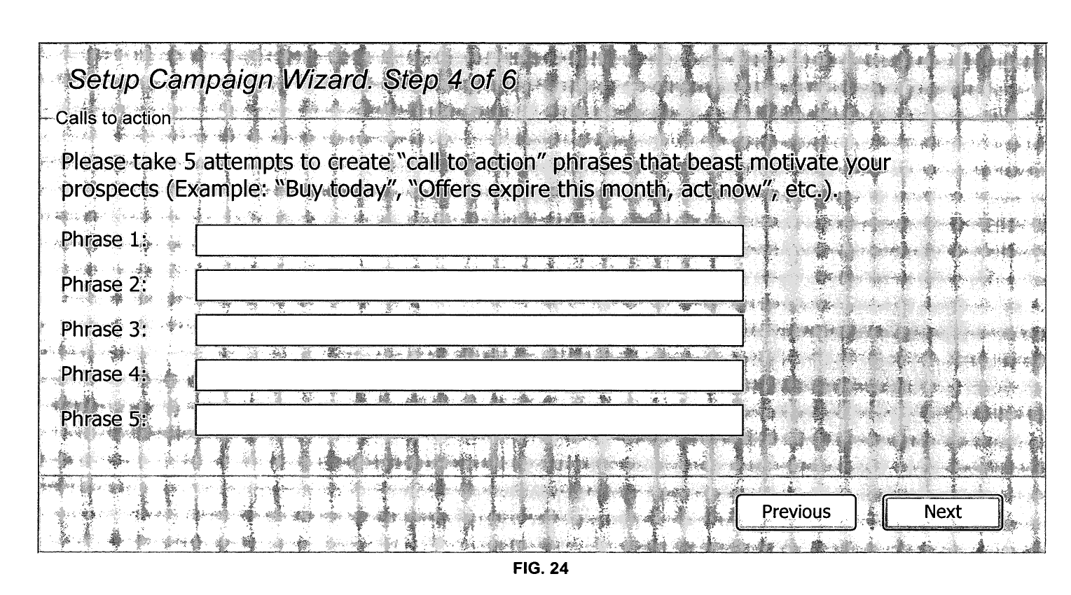

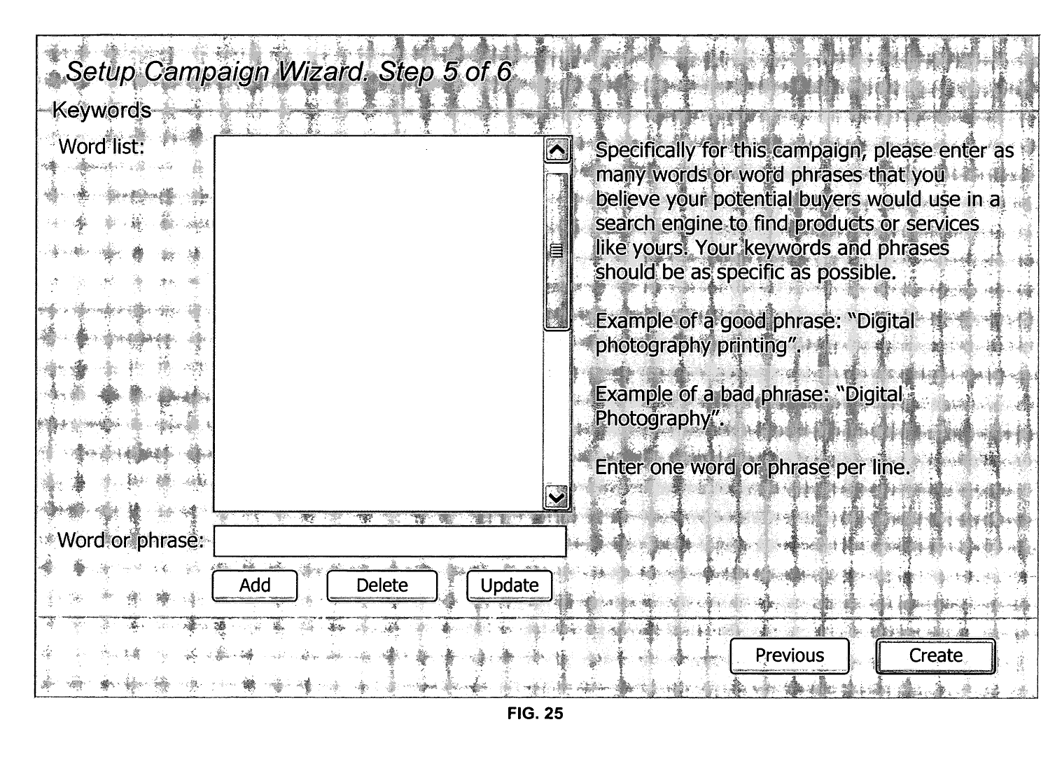

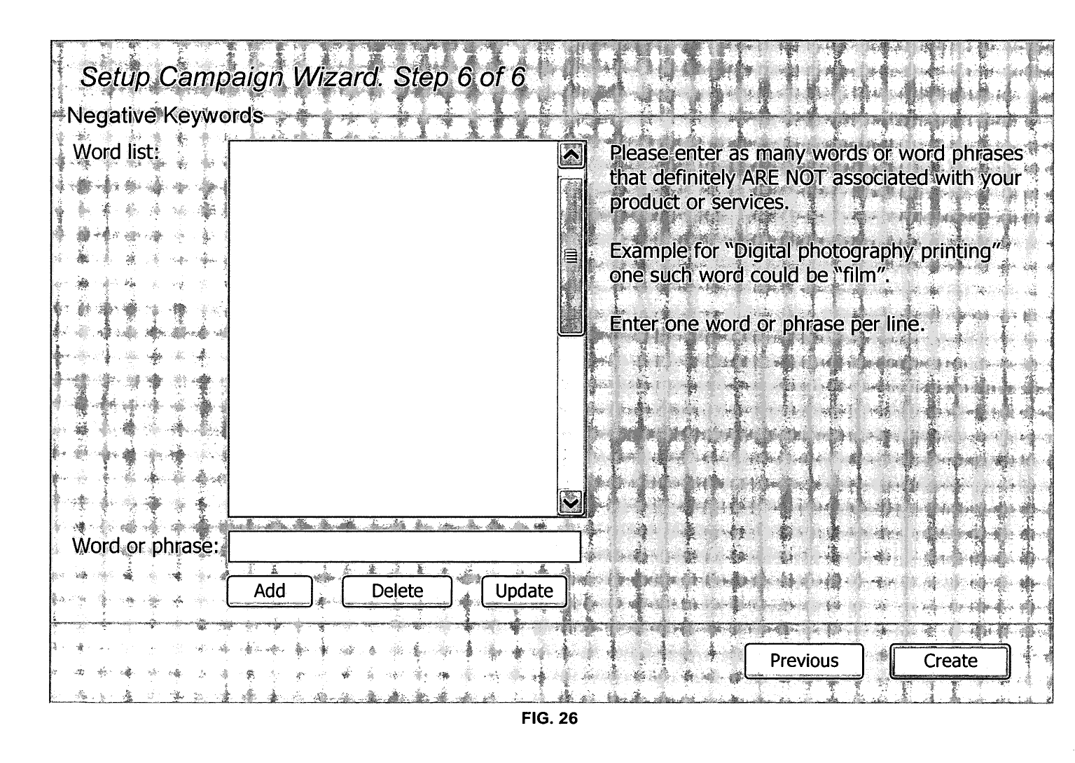

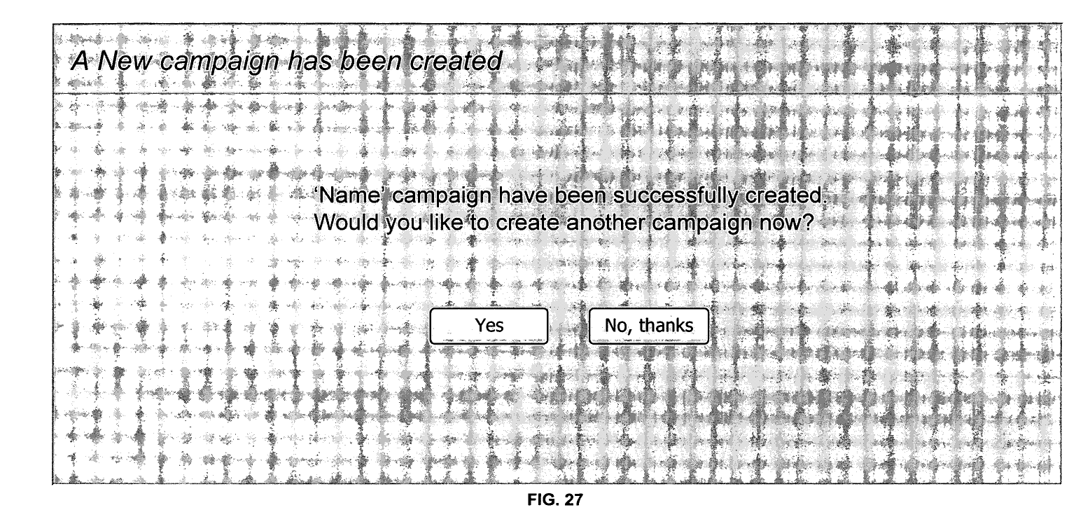

Setup Campaign pages wizard: The content of New Campaign Wizard pages are shown on FIGS. 21-27.

Automatic Optimization Properties pages (User, Campaign, Group, Ad, Keyword): Some setting for the background service—what it does automatically.

History pages (User, Campaign, Group, Ad, Keyword): A list of events for the given object:

1) monitoring status by the background service;

2) background optimization actions;

3) manual optimization actions.

AdWords API Fees Report pages (User, Campaign, Group, Ad, Keyword): Since each call of Adwords API function costs something—we have to collect all the activity, connected with the user and find out a way to charge those expenses to him. And even have a “cost” field on the pages which will call the API functions—how much will it cost.

Ad and Keyword Optimization Wizard pages: They will implement an ability to make some optimization manually if the user wants. Somehow the same steps which the background service will do.

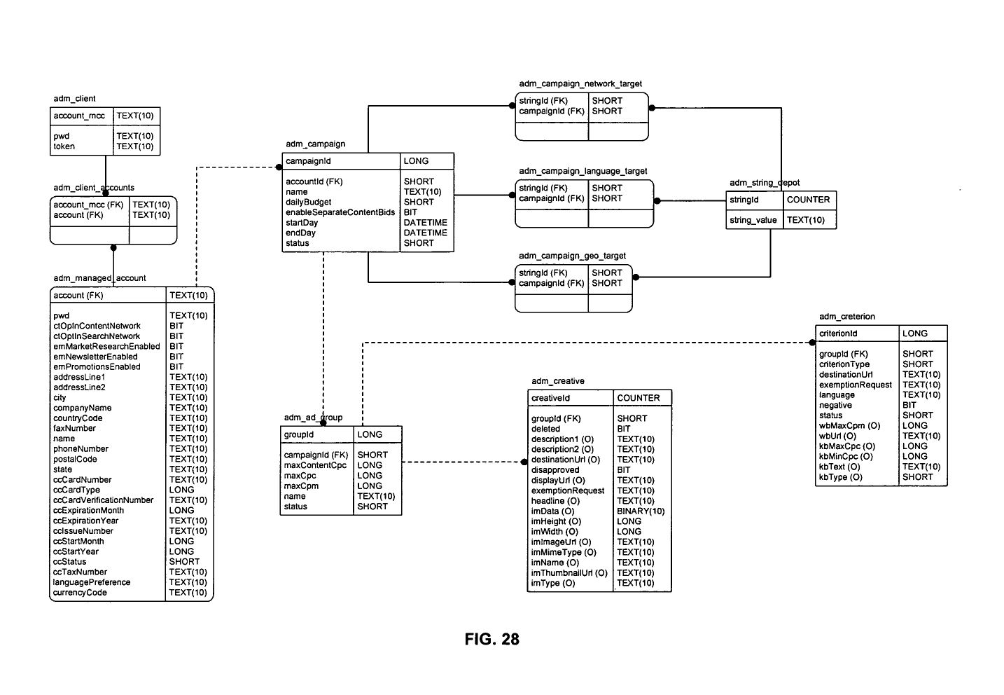

Lastly, a flowchart illustrating an example of the application program interface (API) consistent with the present invention is shown in FIG. 28.

The above-described embodiment of the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAN) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It would be understood that a method incorporating any combination of the details mentioned above would fall within the scope of the present invention as determined based upon the claims below and any equivalents thereof.

What is claimed is:

1. A method for automatically managing a paid search advertising campaign, comprising:
automatically collecting statistical data corresponding to the performance of the advertising campaign;
automatically generating at least one of a keyword and a phrase based on the collected data;
automatically generating an ad linked to the at least one generated keyword or phrase; and
automatically adjusting a bid value corresponding to the at least one keyword or phrase,
wherein the generated ad is displayed on the first results page of a search engine.

2. A system for automatically managing a paid search advertising campaign, the system comprising:
means for automatically collecting statistical data corresponding to the performance of the advertising campaign;
means for automatically generating at least one of a keyword and a phrase based on the collected data;
means for automatically generating an ad linked to the at least one generated keyword or phrase; and
means for automatically adjusting a bid value corresponding to the at least one keyword or phrase,
wherein the generated ad is displayed on the first results page of a search engine.

3. A computer program product for automatically managing a paid search advertising campaign, the program product comprising:
a computer readable medium;
first program instruction means for automatically collecting statistical data corresponding to the performance of the advertising campaign;
second program instruction means for automatically generating at least one of a keyword and a phrase based on the collected data;
third program instruction means for automatically generating an ad linked to the at least one generated keyword or phrase; and
fourth program instruction means automatically adjusting a bid value corresponding to the at least one keyword or phrase,
wherein the generated ad is displayed on the first results page of a search engine.

4. A method for providing information regarding a paid search advertising campaign, the method comprising:
setting a threshold value for each of at least one statistic related to the PPC advertising campaign;
continually monitoring a performance level for each of the at least one statistic related to the PPC advertising campaign; and
automatically generating a notification when the performance level of at least one of the statistics crosses its respective threshold value.

5. A user interface comprising:
first means for indicating a performance level of at least one aspect of a paid search advertising campaign;
second means for enabling a user to add or delete at least one of the at least one aspect whose performance level is indicated by said first means; and
third means for indicating a respective reason for a change in the performance level of the at least one aspect.

6. The user interface claimed in claim 5, wherein said first means comprises a graph indicating the performance of the at least one aspect over time and said third means comprises a window overlayed on a user-selected portion of the graph.

7. A method for automatically managing a paid search advertising campaign, comprising:
monitoring a change in at least one parameter with respect to the paid search advertising campaign;
displaying a graphical representation of the at least one parameter, wherein changes, including the monitored change, in the at least one parameter are represented.

8. The method as claimed in claim 7, further comprising:
determining whether any of the at least one parameters has resulted in an undesirable outcome; and
alerting a user of any parameter determined to result in the undesirable outcome.

9. The method as claimed in claim 7, further comprising:
automatically generating at least one parameter for a specified advertising campaign;
automatically evaluating a level of effectiveness corresponding to the at least one parameter; and
changing a value of the at least one parameter if the level of effectiveness is less than a desired level.

10. The method as claimed in claim 9, wherein said automatic generating and evaluating of the at least one parameter is performed using a line rotation technique.

11. The method as claimed in claim 9, wherein said automatic generation of the at least one parameter comprises generating at least one keyword for the advertising campaign.

12. The method as claimed in claim 11, wherein said generation of the at least one keyword comprises generating a keyword based on one or more rules corresponding to the advertising campaign.

13. The method as claimed in claim 7, further comprising:
determining whether any of the at least one ad or keyword has resulted in an undesirable outcome; and
automatically deleting at least one of either an ad or a keyword that has been determined to have resulted in the undesirable outcome.

14. The method as claimed in claim 9 wherein the at least one parameter comprises one of at least a keyword, an adgroup, a campaign and an ad.

15. The method as claimed in claim 7, further comprising:
presenting a graphical user interface (GUI) to a user, wherein the GUI comprises at least one of, a means for selecting a particular ad campaign to which the displayed graphical representation of the at least one parameter corresponds, means for selecting at least one of best performing and worst performing parameters to be displayed, and a timeframe for which the parameters are to be displayed.
